(19) United States
(12) Patent Application Publication
(10) Pub. No.: US 2009/0239639 A1
(43) Pub. Date: Sep. 24, 2009

(54) Gaming Machine Capable Of Multiplying Award By Rearranging Specific Symbols Consecutively In A Free Game

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/403,068

(22) Filed: Mar. 12, 2009

Related U.S. Application Data
(60) Provisional application No. 61/038,963, filed on Mar. 24, 2008.

(51) Int. Cl. A63F 9/24; A63F 13/00

(52) U.S. Cl. 463/20; 463/31

(57) ABSTRACT

A gaming machine 10 starts a game, advances the game to a free game under a predetermined condition, and in a case where a specific symbol is consecutively displayed in a symbol display area for providing an award during the free game, increases (by addition or multiplication) an award based on the number of consecutive games in which the specific symbol is rearranged. Regarding providing an award, a base award is cumulatively increased when the specific symbol is consecutively rearranged in each round of the free game, or the base award is multiplied (or added) by a value corresponding to the number of consecutive games in which the specific symbol is rearranged during the previous game.

### CROSS REFERENCE TO RELATED APPLICATIONS

This application claims benefit of U.S. Provisional Application No. 61/038,963, filed Mar. 24, 2008, the entire contents of which are incorporated herein by reference.

### BACKGROUND OF THE INVENTION

1. Field of the Invention

The present invention relates to gaming machines that performs slot games in which each of a plurality of symbols are rearranged and free games in which a multiplier can be changed.

2. Related Art

It is known that conventional slot machines start a game when a predetermined amount of credit is bet, then start to rotate a plurality of reels on which a plurality of symbols is depicted, and stop the rotation after a predetermined period of time elapses. As a result, a certain award is provided to a player based on a stationary combination of symbols.

U.S. Pat. No. 7,338,370 discloses display screens of a slot machine for entering a bonus game from a base game. In the basic game, a multiplier of a bonus game award, which is multiplied for an amount of coins a player bet, is selectably determined and displayed in a display screen. Furthermore, during the bonus game, when the player selects one bonus symbol among a plurality of bonus symbols, a bonus game award corresponding to the selected bonus symbol is displayed. Moreover, an amount of bets carried over from the basic game and the multiplier selected based on the carry-over bet amount are displayed. In addition, the bonus game award and a total award, that is, the bonus game award multiplied by the multiplier are displayed, whereby the player can recognize the total amount to be paid out in the bonus game. In other words, the multiplier for the total award to be paid out in the bonus game is gradually determined based on the base game.

In such a slot game as described above, a bonus game depends somewhat on a bet amount in a base game and a multiplier selected based on the bet amount in the base game. Since it is difficult for a player to calculate a total award of a bonus game, a display screen for displaying guidance and the like is required. This interrupts a smooth flow of switching from a base game to a bonus game. In this way, the progress of a bonus game is far from speedy and exciting due to an adverse effect of excessively preceding expectation produced by the player.

### SUMMARY OF THE INVENTION

The present invention has an object to provide a gaming machine that can provide a player-friendly game with speed and excitement, and which can change a multiplier for the game, without interruption of the flow of the game.

Furthermore, the present invention has an object to provide a gaming machine which can further improve entertainment properties.

In the first aspect of the present invention, a gaming machine includes:

a display having a plurality of symbol display regions and displaying a symbol to be rearranged in each of the symbol display regions for each round of a game;

an input device for starting a basic game in which an award is provided based on an arrangement of symbols rearranged in a symbol display area for providing an award, the symbol display area including the plurality of symbol display regions on the display, a type of the award being determined according to one of a number of identical symbols and a combination of symbols lying along an active line; and

a controller configured to execute the processing including:

(a) starting a basic game, and after performing at least one round of the basic game, switching the basic game to a free game;

(b) rearranging a predetermined symbol randomly in each region of the symbol display area for providing an award on the display for each round of the free game; and

(c) if an arrangement of symbols rearranged in the symbol display area for providing an award matches an arrangement entitled to a predetermined award after a plurality of rounds of the free game, increasing an amount of payout for the predetermined award according to a number of consecutive rounds previously played of the free game in each of which a specific symbol is rearranged in the symbol display area for providing an award.

In the second aspect of the present invention, a gaming machine includes:

a display having a plurality of symbol display regions and displaying a symbol to be rearranged in each of the symbol display regions for each round of a game;

an input device for starting a basic game in which an award is provided based on an arrangement of symbols rearranged in a symbol display area for providing an award, the symbol display area including the plurality of symbol display regions on the display, a type of the award being determined according to one of a number of identical symbols and a combination of symbols lying along an active line; and

a controller configured to execute the processing including:

(a) starting a basic game, and after performing at least one round of the basic game, switching the basic game to a free game;

(b) rearranging a predetermined symbol randomly in each region of the symbol display area for providing an award on the display for each round of the free game;

(c) at the end of each round of the free game, updating and storing a number of consecutive rounds of the free game in each of which a specific symbol is rearranged in the symbol display area for providing an award; and

(d) if the specific symbol is not rearranged in the symbol display area for providing an award in one round of the free game, providing an award based on the number of consecutive rounds of the free game in each of which the specific symbol is rearranged, the number being stored in the previous round of the free game.

In the third aspect of the present invention, a gaming machine includes:

a display having a plurality of symbol display regions and displaying a symbol to be rearranged in each of the symbol display regions for each round of a game;

an input device for starting a basic game in which an award is provided based on an arrangement of the symbols rearranged in a symbol display area for providing an award, the symbol display area including the plurality of symbol display regions on the display, a type of the award being determined according to one of a number of identical symbols and a combination of symbols lying along an active line; and

a controller configured to execute the processing including:

(a) starting a basic game, and after performing at least one round of the basic game, switching the basic game to a free game;

(b) rearranging a predetermined symbol randomly in each region of the symbol display area for providing an award on the display for each round of the free game;

(c) at the end of each round of the free game, updating and storing a number of consecutive rounds of the free game in each of which a specific symbol is rearranged in the symbol display area for providing an award; and

(d) if the specific symbol is not rearranged in the symbol display area for providing an award in one round of the free game, providing an award based on a payout table that correlates a payout with the number of consecutive rounds of the free game in each of which the specific symbol is rearranged, the number being stored in the previous round of the free game.

In the fourth aspect of the present invention, a gaming machine includes:

a display having a plurality of symbol display regions and displaying a symbol to be rearranged in each of the symbol display regions for each round of a game;

an input device for starting a basic game in which an award is provided based on an arrangement of symbols rearranged in a symbol display area for providing an award, the symbol display area including the plurality of symbol display regions on the display, a type of the award being determined according to one of a number of identical symbols and a combination of symbols lying along an active line; and

a controller configured to execute the processing including:

(a) starting a basic game, and after performing at least one round of the basic game, switching the basic game to a free game;

(b) rearranging a predetermined symbol randomly in each region of the symbol display area for providing an award on the display for each round of the free game;

(c) at the end of each round of the free game, updating and storing a number of consecutive rounds of the free game in each of which a specific symbol is rearranged in the symbol display area for providing an award; and

(d) if the specific symbol is not rearranged in the symbol display area for providing an award in one round of the free game, increasing an amount of an award determined based on an arrangement of symbols displayed in the symbol area for providing an award, which has triggered a switch from the basic game to the free game in processing (a), according to the number of consecutive rounds of the free game, which is stored in the previous round of the free game in which the specific symbol is rearranged, and providing the increased amount of the award.

In the fifth aspect of the present invention, a gaming machine includes:

a display having a plurality of symbol display regions and displaying a symbol to be rearranged in each of the symbol display regions for each round of a game;

an input device for starting a basic game in which an award is provided based on an arrangement of symbols rearranged in a symbol display area for providing an award, the symbol display area including the plurality of symbol display regions on the display, a type of the award being determined according to one of a number of identical symbols and a combination of symbols lying along an active line; and

a controller configured to execute the processing including:

(a) starting a basic game, and after performing at least one round of the basic game, switching the basic game to a free game;

(b) rearranging a predetermined symbol randomly in each region of the symbol display area for providing an award on the display for each round of the free game;

(c) at the end of each round of the free game, updating and storing a number of consecutive rounds of the free game in each of which a specific symbol is rearranged in the symbol display area for providing an award;

(d) if an arrangement of the symbols displayed in the symbol display area for providing an award matches an arrangement entitled to an award as a result of a round of the free game, providing the award according to the number of consecutive rounds of the free game cumulatively stored in processing (c) in each of which the specific symbol is rearranged; and

(e) if the specific symbol is not rearranged in the symbol display area for providing an award, resetting the number of consecutive rounds of the free game in processing (c) in each of which the specific symbol is rearranged, and performing subsequent rounds of the free game.

According to abovementioned each aspect of the present invention, a player advances a game to a free game from a basic game, and in a case where the specific symbol is consecutively rearranged in the symbol display area for providing an award during the free game, an award is increased (by addition or multiplication) based on the number of consecutive rounds of the free game in each of which the specific symbol is rearranged. Such a configuration makes the game, in which the specific symbol and the symbol display regions (symbol display positions) are visually related to the award (increase of the award) directly, easier to operate for a player. Accordingly, the gaming machine provides a game with speedy and exciting progress, allowing the player to feel more excited. Since the player is allowed to select the specific symbol, the player may feel further excited.

### BRIEF DESCRIPTION OF THE DRAWINGS

FIG. 1 is a flow chart showing a flow of a game executed in a gaming machine according to an embodiment of the present invention;

FIG. 2 is a perspective view showing an appearance of the gaming machine according to the embodiment of the present invention;

FIG. 3 is a plan view showing an enlarged display area of the gaming machine according to the embodiment of the present invention;

FIG. 4 is a block diagram illustrating a controller of the gaming machine according to the embodiment of the present invention;

FIG. 5 is a block diagram illustrating a display/input controller of the gaming machine according to the embodiment of the present invention;

FIG. 6 is a flow chart showing mainly a flow of basic game processing of the gaming machine according to the embodiment of the present invention;

FIGS. 7 and 8 are flow charts each showing an example of a portion of processing in FIG. 6;

FIG. 9 is a payout table related to a free game according to the embodiment of the present invention; and

FIGS. 10 and 11 are examples each depicting a display screen of a rendered image of a game performed by the gaming machine according to the embodiment of the present invention.

### DETAILED DESCRIPTION OF THE INVENTION

The gaming machine according to the present invention is hereinafter described in detail with reference to attached drawings. The present embodiments may preferably, but not necessarily, be applied to a gaming machine such as a slot game. An example of such a gaming machine includes a gaming machine that has an image displaying device such as a liquid crystal display and that advances a game while displaying images of various kinds of symbols on the image displaying device.

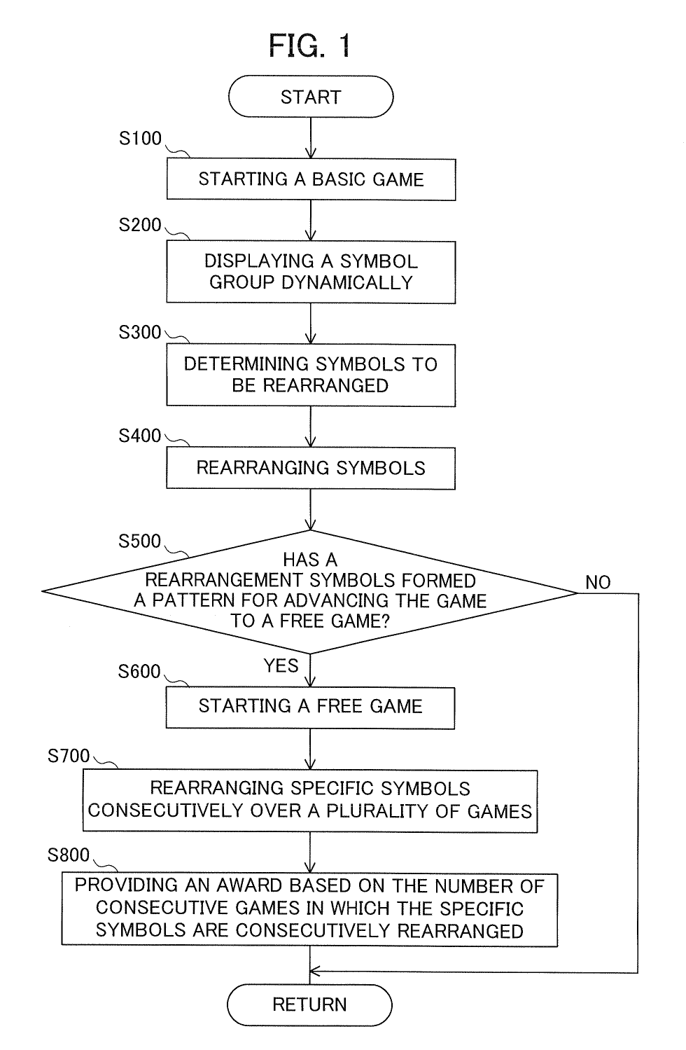

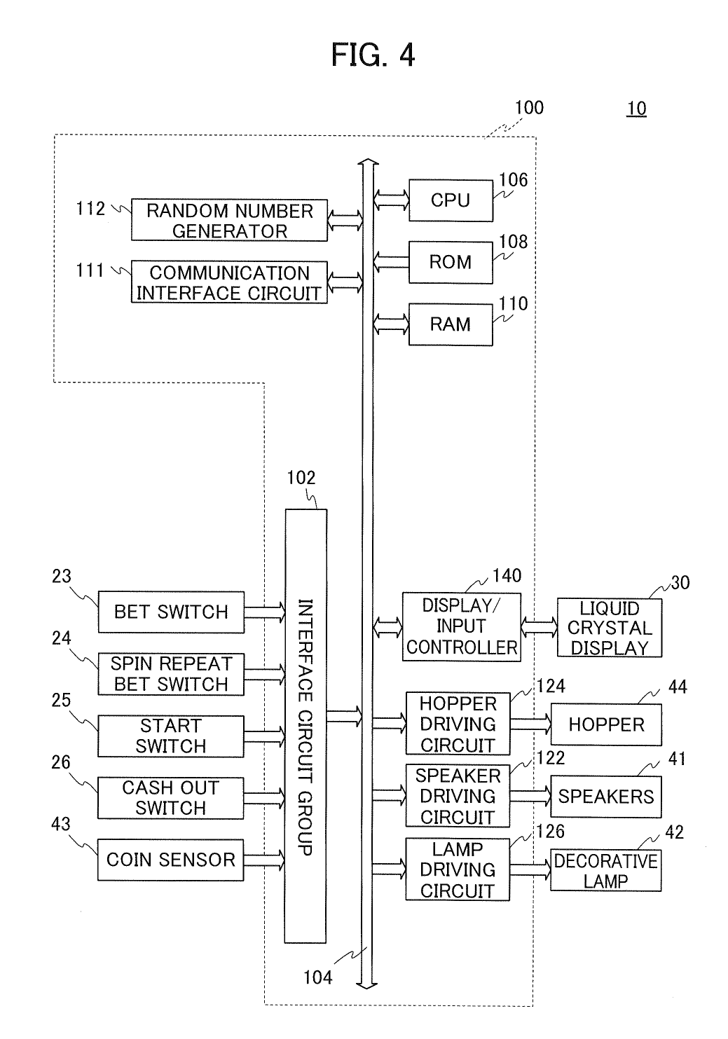

FIG. 1 is a flow chart showing a flow of a game executed in a gaming machine according to an embodiment of the present invention. As shown in FIG. 1, a CPU 106 (refer to FIG. 4) starts a basic game (Step S100), displays dynamically a set of symbols (Step S200), determines symbols to be rearranged (Step S300), and rearranges the symbols (Step S400), the details of which will be described later. Next, the CPU 106 determines whether the rearranged symbols match a combination for allowing a game to advance to a free game, and in a case where the CPU 106 determines an occurrence of matching, the CPU 106 starts a free game (Step S600). The CPU 106 rearranges specific symbols consecutively over a plurality of free games (Step S700), and provides an award based on the number of consecutive rounds of the free game in each of which the specific symbol is rearranged (Step S800).

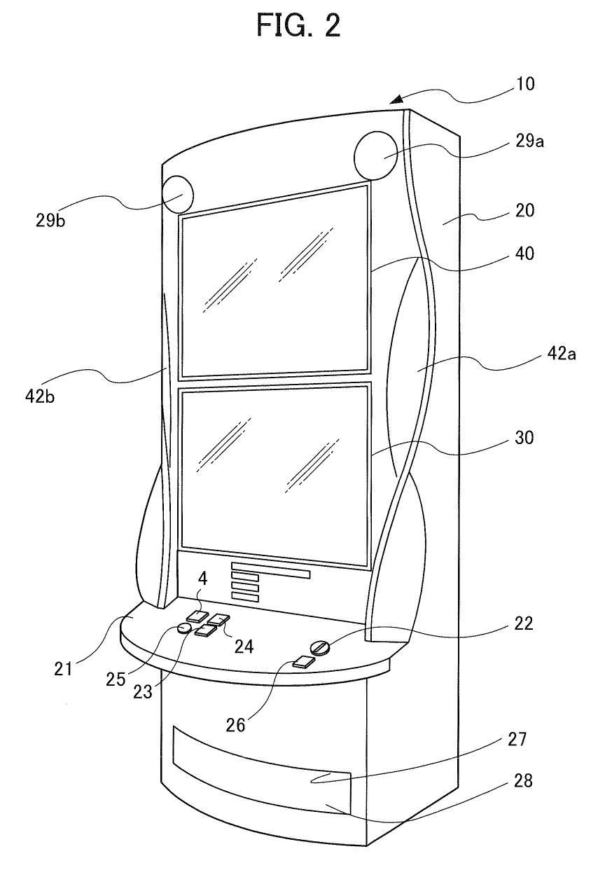

FIG. 2 is a perspective view showing an appearance of the gaming machine according to the embodiment of the present invention.

A gaming machine 10 includes a cabinet 20. The cabinet 20 has a structure in which the face facing a player is open. The cabinet 20 contains various components, including a game controller 100 (refer to FIG. 4) for electrically controlling the gaming machine 10 and a hopper 44 (refer to FIG. 4) for controlling the insertion, storage, and payout of coins (game media), and the like. The game medium is not restricted to coins. In addition, examples of such game media include medals, tokens, electronic money, or electronic value information (credit) having the same value.

A liquid crystal display 30 is provided substantially at the center in a front surface of the cabinet 20. The liquid crystal display 30 realizes a display device for displaying various kinds of images related to a game including rendered images and the like. The gaming machine 10 includes an image display device such as the liquid crystal display 30, and advances the game while displaying various kinds of symbol images on the image display device.

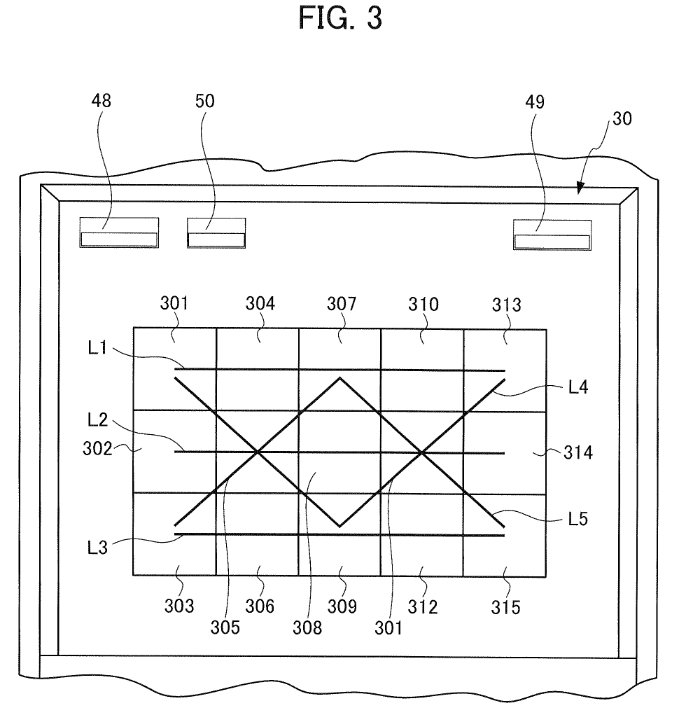

The liquid crystal display 30 includes symbol display regions 301 to 315 of a plurality of divisions (refer to FIG. 3), and repeatedly displays for each game rearrangement of a plurality of kinds of symbols in a symbol display area for providing an award that is formed by the symbol display regions 301 to 315. The symbol display regions 301 to 315 are configured with video reels for displaying a plurality of virtual reels, for example. It should be noted that the term “video reel” as used here represents a device for displaying a reel on the liquid crystal display 30 in a form of an image instead of mechanical reel. In the present embodiment, fifteen video reels are displayed on the liquid crystal display 30. In other words, there are provided the symbol display regions (301 to 315) of fifteen divisions.

A start switch 25, which is one input device, is provided on an operation unit 21 placed below the liquid crystal display 30. Upon operation of the start switch 25, a game is started, in which an award is provided corresponding to a number of identical symbols (of the same kind) rearranged in the symbol display area for providing an award that is formed by the symbol display regions 301 to 315. Other rearrangement patterns for providing an award may include forming a combination of symbols along one of active lines such as L1 to L5 as shown in FIG. 3. In the present embodiment, the rearrangement pattern presented with a combination of symbols along an active line is set as a trigger for switching a game to a free game, for example.

Another liquid crystal display 40 may be further provided above the liquid crystal display 30. The liquid crystal display 40 can be utilized as a sub display for displaying game rules, a demonstration screen and the like. Sound transmitting openings 29a and 29b, which are provided near the upper portion of the cabinet 20, transmit sound effects, generated by speakers 41 (refer to FIG. 4) contained in the cabinet 20, to the outside of the cabinet 20. The sound transmission openings 29a and 29b generate sound effects and the like in accordance with the progress of the game. Decorative lamps 42a and 42b are disposed on both right and left sides substantially in the center of the gaming machine 10 and emit light in accordance with the progress of the game.

On a substantially flat operation unit 21 disposed at a lower portion of the liquid crystal display 30, a coin insertion slot 22, a bet switch 23, and a spin repeat bet switch 24 are provided, besides the start switch 25. The bet switch 23 selects an amount of coins to be bet for a game among a plurality of coins inserted from the coin insertion slot 22. The spin repeat bet switch 24 starts a game without changing the amount of coins to be bet from the amount of coins bet in a previous game. Such arrangements allow a player to set the amount of coins to be bet for a group of symbols to be formed on activated lines in response to a pushing operation of the bet switch 23 or the spin repeat bet switch 24. The start switch 25 accepts a starting operation of a game by a player for each game. Triggered by a pressing operation applied to one of the start switch 25 and the spin repeat bet switch 24, the liquid crystal display 30 displays a display of a dynamic image indicating the plurality of the symbol display regions 301 to 315.

A cash out switch 26 is provided near the coin insertion slot 22 on the operation unit 21. Upon a pushing operation on the cash out switch 26 by a player, inserted coins are discharged through a coin payout opening 27 provided at a lower portion of the front face of the cabinet 20. The coins thus discharged are retained in a coin tray 28.

FIG. 3 is an enlarged display area of the liquid crystal display 30 of the gaming machine 10. The symbol display regions 301 to 315 included in such a display area form a matrix of three rows and five columns, which are also called symbol display blocks and symbol display positions. Fifteen video reels are provided to the symbol display regions 301 to 315, respectively.

A payout amount display unit 48, a bet amount display unit 50, and a credit amount display unit 49 are displayed in this order from the left side on the upper portion of the liquid crystal display 30. The payout display 48 displays a payout amount of coins, in a case where at least a predetermined number of identical symbols for providing an award is arranged, when symbols are dynamically displayed and rearranged in the symbol display area for providing an award that is formed by the symbol display regions 301 to 315, for example. The credit amount display unit 49 displays the credit amount of coins stored in the gaming machine 10. The bet amount display unit 50 displays a bet number, which is the amount of coins being bet.

FIG. 4 is a block diagram showing the electrical configuration of the game controller 100 of the gaming machine 10. The controller 100 of the gaming machine 10 is a microcomputer, and includes an interface circuit group 102, a CPU 106, a ROM 108, a RAM 110, a communication interface circuit 111, a random number generator 112, a speaker driving circuit 122, a hopper driving circuit 124, a lamp driving circuit 126, and a display/input controller 140. These components mentioned above are connected with an input/output bus 104.

The input/output bus 104 transmits the input/output of data signals or address signals to and from the CPU 106. The start switch 25 is electrically connected with the interface circuit group 102. A start signal generated by the start switch 25 is converted into a predetermined form of signal in the interface circuit group 102 to be supplied to the input/output bus 104.

The bet switch 23, the spin repeat bet switch 24, and the cash out switch 26 are also connected with the interface circuit group 102. Each of the switching signals output from these switches 23, 24, and 26 is also supplied to the interface circuit group 102, and is converted into a predetermined form of signal by the interface circuit group 102 to be supplied to the input/output bus 104.

A coin sensor 43 is also electrically connected with the interface circuit group 102. The coin sensor 43 detects coins inserted into the coin insertion slot 22 and is disposed at an appropriate position relative to the coin insertion slot 22. A sensing signal output from the coin sensor 43 is also supplied to the interface circuit group 102, and is converted into a predetermined form of signal by the interface circuit group 102, to be supplied to the input/output bus 104.

Upon acceptance of a start operation of a game via the start switch 25, the CPU 106 reads a game program and performs the game. The game program causes the liquid crystal display 30 to start to dynamically display a set of symbols by way of a video reel in each of the symbol display regions 301 to 315 by which the symbol display area for providing an award is formed, via the display/input controller 140, and subsequently rearranges the set of symbols. In a case where there is at least the predetermined number of identical symbols among all the rearranged symbols, the program is configured so as to instruct payout of coins corresponding to the number of identical symbols.

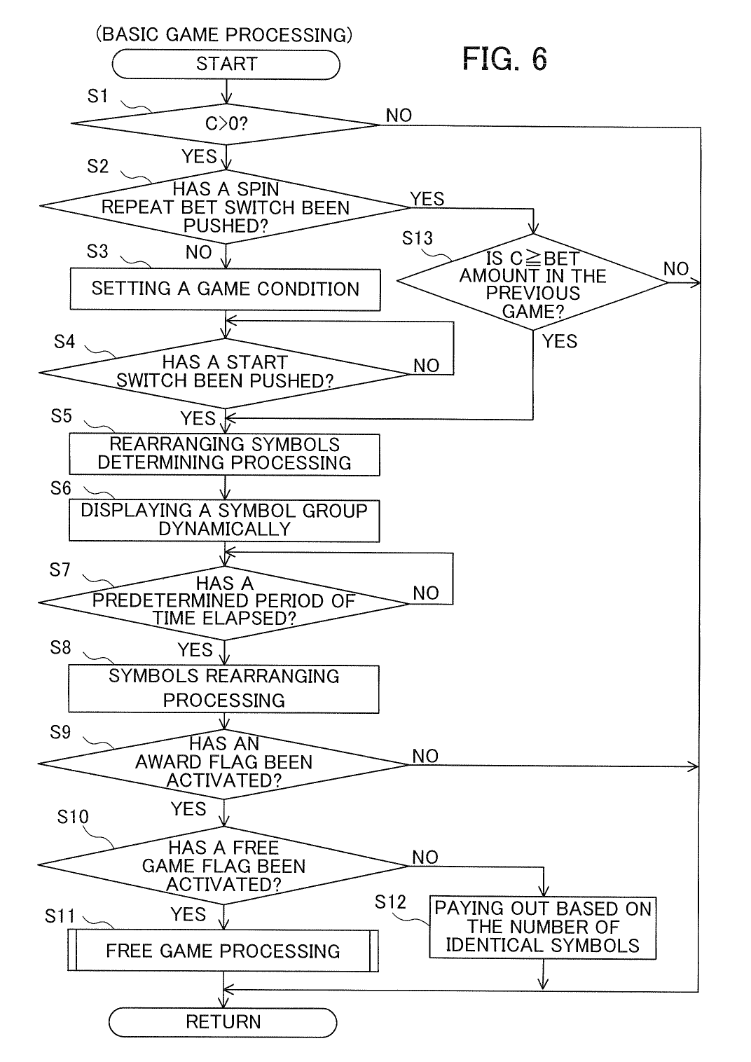

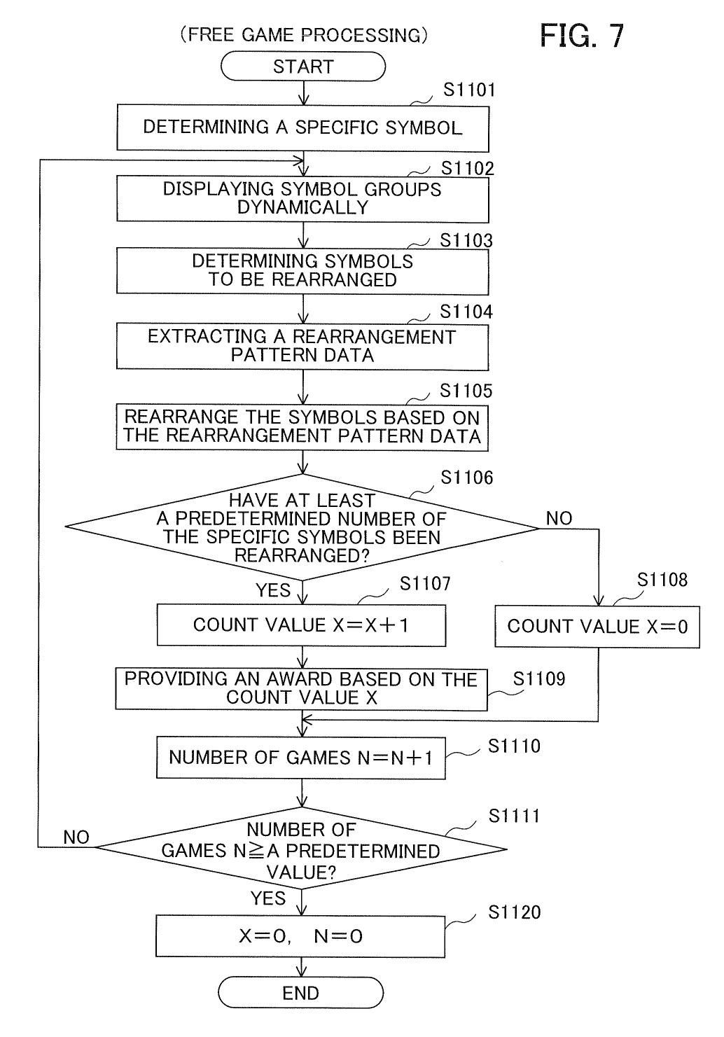

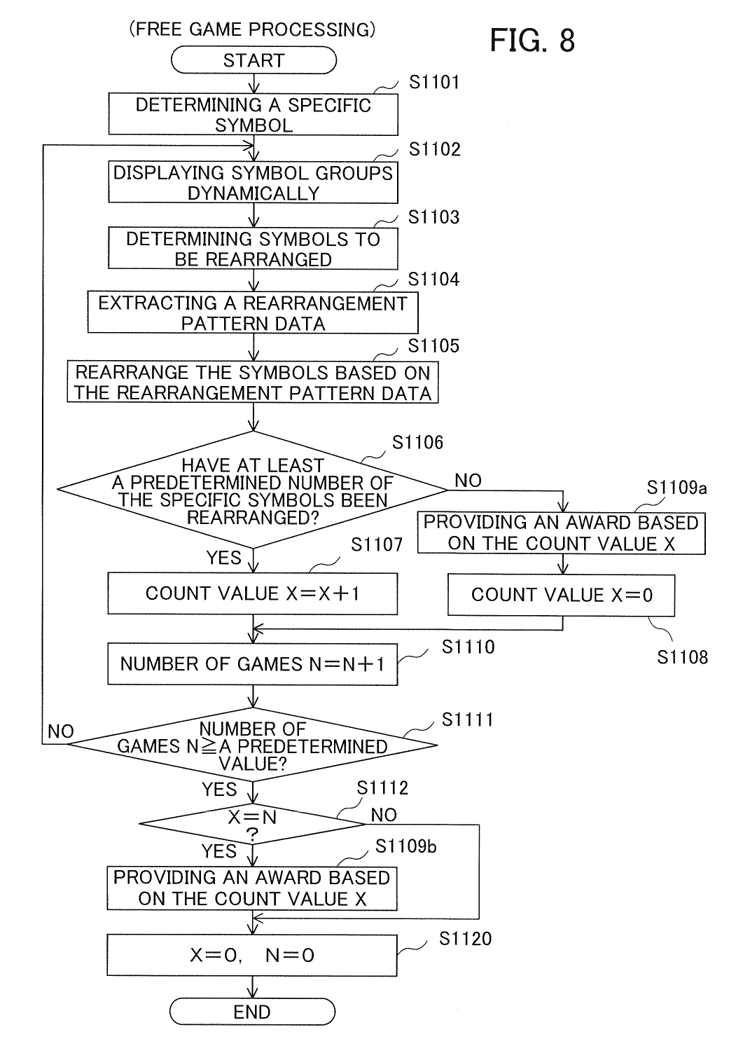

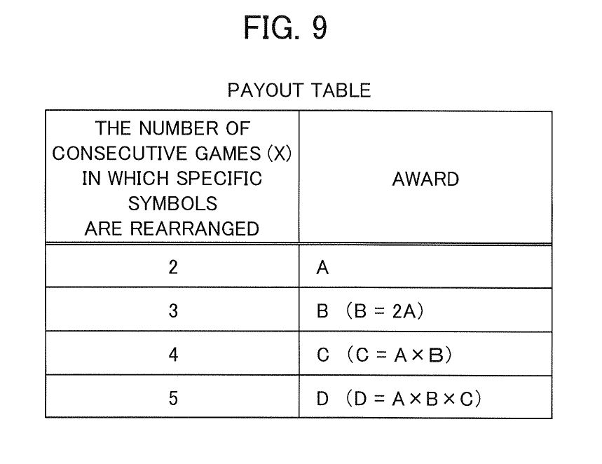

The ROM 108 stores a control program for centrally controlling the gaming machine 10, a program for executing routines shown in FIGS. 6 and 7, or FIGS. 6 and 8 (hereinafter referred to as a “routine program”), initial data for executing the control program, and various data tables used for determining processing. The routine program includes the abovementioned game program. The data tables shown in FIG. 9 and the like are examples of data tables. The RAM 110 temporarily stores flags, variables, and the like used for the control program.

The game program includes a program for determining symbols to be rearranged. This program determines fifteen symbols to be rearranged in the symbol display regions 301 to 315, respectively. The program includes symbol weighting data that corresponds to each of a plurality of kinds of payout ratios (e.g., 80%, 84%, and 88%). The symbol weighting data indicates the correlation between a symbol and one or a plurality of random numbers in a predetermined number range (0 to 256) for each of the fifteen video reels. A payout ratio is determined based on data related to setting of payout ratios stored in the ROM 108. The rearrangement of symbols is determined based on the symbol weighting data corresponding to the payout ratio.

The communication interface circuit 111 communicates with a server and a central controller via various kinds of communication networks, such as a LAN.

A random number generator 112 generates random numbers lying in a predetermined range of “0” to “65535” (two to the sixteenth power minus one), for example. Alternatively, the CPU 106 may generate a random number by computation.

The speaker driving circuit 122 drives the speakers 41. The CPU 106 reads sound data stored in the ROM 108 and transmits the sound data thus read to the speaker driving circuit 122 via the input/output bus 104. In this way, the speakers 41 generate predetermined sound effects.

The hopper driving circuit 124 drives the hopper 44. The CPU 106 outputs a driving signal to the hopper driving circuit 124 via the input/output bus 104 in response to receiving a cash out signal from the cash out switch 26. Accordingly, the hopper 44 pays out an amount of coins equivalent to the current amount of remaining credits, which is stored in a predetermined memory area of the RAM 110.

Alternatively, payout of coins may be performed by way of storing credit data in a data card and the like, instead of using physical coins. In other words, the player may carry a card which serves as a recording medium, and store the data related to the credit by inserting the card into the gaming machine 10.

The lamp driving circuit 126 drives the decorative lamps 42a and 42b. The CPU 106 transmits the signal for driving the lamps according to predetermined conditions based on the program stored in the ROM 108, to the lamp driving circuit 126. Thus, the decorative lamps 42a and 42b blink and the like.

The display/input controller 140 generates a signal for driving the liquid crystal displays 30 and 40 according to an image display instruction. The CPU 106 generates an image display instruction according to the status and outcome of a game, and outputs the image display instruction thus generated to the display/input controller 140 via the input/output bus 104. Upon reception of the image display instruction from the CPU 106, the display/input controller 140 generates a driving signal for driving the liquid crystal displays 30 and 40 according to the image display instruction thus input, and outputs the driving signal thus generated to the liquid crystal displays 30 and 40. Consequently, a predetermined image is displayed on the liquid crystal displays 30 and 40. The display/input controller 140 transmits the signal input via the touch panel 32 provided on the liquid crystal display 30 to the CPU 106 via the input/output bus 104 in the form of an input signal. In addition, the image display instruction includes instructions for the payout display unit 48, the credit amount display unit 49, and the bet amount display unit 50.

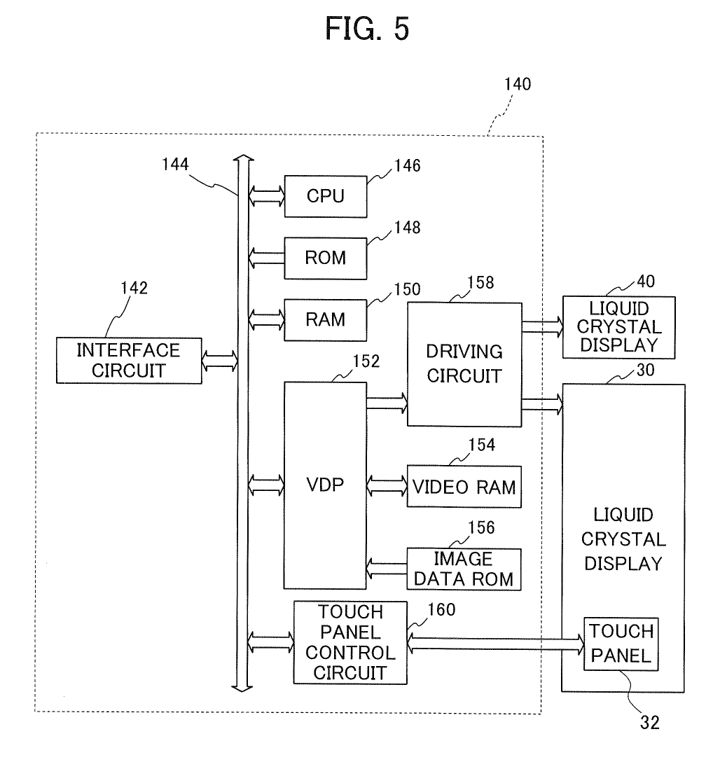

FIG. 5 is a block diagram showing the electrical configuration of the display/input controller 140 of the gaming machine 10. The display/input controller 140 of the gaming machine 10 is a sub-microcomputer which executes image display processing and controls input from the touch panel 32. The display/input controller 140 includes an interface circuit 142, a CPU 146, a ROM 148, a RAM 150, a VDP 152, a video RAM 154, a ROM 156 for storing image data, a driving circuit 158, and a touch panel controlling circuit 160. These components are connected with an input/output bus 144.

An image display instruction output from the CPU 106 of the game controller 100 is supplied to the input/output bus 144 via the interface circuit 142. The input/output bus 144 inputs and outputs data signals and address signals to and from the CPU 146.

The ROM 148 stores a display control program for generating a driving signal to be supplied to the liquid crystal displays 30 and 40 according to the image display instruction from the CPU 106 of the game controller 100. The RAM 150 stores flags and variables used for the display control program.

The VDP 152 includes a so-called sprite circuit, a screen circuit, a palette circuit, and the like, and performs various kinds of processing for displaying images on the liquid crystal displays 30 and 40. The video RAM 154 and the image data ROM 156 are connected to the VDP 152. The video RAM 154 stores image data based on the image display instructions from the CPU 106 of the game controller 100. The image data ROM 156 stores various kinds of image data including the abovementioned rendered image data. The driving circuit 158 for outputting a driving signal to drive the liquid crystal displays 30 and 40 is connected to the VDP 152.

The CPU 104 reads and executes the display control program stored in the ROM 148, and instructs the video RAM 154 to store image data to be displayed on the liquid crystal displays 30 and 40 according to the image display instruction from the CPU 106 of the game controller 100. The image display instruction includes various kinds of instructions including an instruction for displaying the abovementioned rendered image and the like.

The image data ROM 156 stores various kinds of image data including the image data for the rendered image and the like. The touch panel control circuit 160 transmits a received input signal via the touch panel 32 provided on the liquid crystal display 30, to the CPU 106 via the input/output bus 144 in the form of an input signal.

FIG. 6 is a flow chart showing processing mainly for a basic game of the gaming machine 10 executed by the game controller 100 of the gaming machine 10. If one routine shown in FIG. 6 is thoroughly performed, it will result in a unit game. A description is provided with reference to FIGS. 3 to 5.

It is supposed that the gaming machine 10 is activated in advance, and that the variables used in the CPU 106 of the controller 100 are initialized to predetermined values, whereby the gaming machine 10 is in normal operation.

Firstly, the CPU 106 of the game controller 100 determines whether there remains a certain amount of credit which is equivalent to a remaining amount of coins a player has inserted (Step S1). More specifically, the CPU 106 reads a credit amount C stored in the RAM 110, and executes a processing based on the credit amount C thus read. In a case where the credit amount C is “0” (“NO” in Step 51), the CPU 106 terminates the routine without any processing since a game cannot be allowed to start. On the other hand, in a case where the credit amount C is at least “1” (“YES” in Step 51), the CPU 106 determines that there are credits remaining, and advances the processing to Step S2.

In Step S2, the CPU 106 determines whether a pushing operation has been executed on a spin repeat bet switch 24. When the spin repeat bet switch 24 has been pushed, and accordingly, an operation signal from the spin repeat switch 24 has been input to the CPU 106 (“YES” in Step S2), the CPU 106 advances the processing to Step S13. On the other hand, in a case where the CPU 106 receives no operation signal from the spin repeat bet switch 24 during a predetermined period of time (“NO” in Step S2), the CPU 106 determines that the spin repeat bet switch 24 has not been pushed, and advances the processing to Step S3.

In Step S3, the CPU 106 sets game conditions. More specifically, the CPU 106 determines the amount of coins to be bet for a unit game based on the operation of the bet switch 23. Here, the CPU 106 receives an operation signal delivered in response to the operation of the bet switch 23, and based on the number of times the CPU 106 has received the signal, the CPU 106 stores a bet amount in a predetermined memory area of the RAM 110. The CPU 106 reads a credit amount C stored in a predetermined area of RAM 110, subtracts the abovementioned bet amount from the credit amount C thus read, and stores the resulting value in a predetermined memory area of the RAM 110. Subsequently, the CPU 106 advances the processing to Step S4.

In the Step S4, the CPU 106 determines whether the start switch 25 has been activated, and stands by until the start switch 25 is operated. Upon the start switch 25 being operated, and accordingly, upon the CPU 106 receiving an operation signal from the start switch 25 (“YES” in Step S4), the CPU 106 determines that the start switch 25 has been operated, and advances the processing to Step S5.

On the other hand, in Step S13, the CPU determines whether the credit amount C is equal to or greater than the bet amount in a previous game. In other words, the CPU 106 determines whether the CPU 106 can start a game in response to a pushing operation performed on the spin repeat bet switch 24. More specifically, when the spin repeat bet switch 24 has been pushed and accordingly the CPU 106 has received an operation signal from the spin repeat bet switch 24, the CPU 106 reads the credit amount C and the bet amount in a previous game from the RAM 110, and executes processing based on whether the credit amount C is equal to or greater than the bet amount in the previous game. In a case where the CPU 106 determines that the credit amount C is less than the bet amount in the previous game (“NO” in Step S13), the CPU 106 terminates the routine without executing any processing, since the game is not allowed to start. On the other hand, in a case where the CPU 106 determines that the credit amount C is equal to or greater than the bet amount in the previous game (“YES” in Step S13), the CPU 106 subtracts the bet amount in the previous game from the credit amount C, and stores the resulting value in a predetermined area of the RAM 110. Subsequently, the CPU 106 advances the processing to Step S5.

In Step S5, the CPU 106 executes processing for determining symbols to be rearranged. A detailed description of this processing is provided below.

Firstly, the CPU 106 extracts a random number from the random number generator 112 and selects a random number for each of the fifteen video reels in a range of random numbers 0 to 255. Next, the CPU 106 reads data for setting payout ratios from the ROM 108 and stores the data in the RAM 110, refers to data for weighting symbols correlated with the data for setting payout ratios, and determines a symbol to be rearranged in each of the symbol display regions 301 to 315 corresponding to the fifteen video reels, based on the fifteen random numbers thus selected. In the present embodiment, in a case where at least five identical symbols (of the same kind) are rearranged in the symbol display regions 301 to 315, the CPU 106 is configured so as to provide an award corresponding to the rearranged symbols.

Following the determination of symbols to be rearranged, the CPU 106 determines whether at least a predetermined number (five) of identical symbols entitled to an award is to be rearranged during the rearrangement of the fifteen symbols. In a case where the CPU 106 determines that at least the predetermined number (five) of the identical symbols is to be rearranged, the CPU 106 activates an award flag indicating an upcoming award so as to provide an award corresponding to the identical symbols described above. The CPU 106 stores the award flag in a predetermined memory area of the RAM 110. On the other hand, in a case where the CPU 106 does not determine that at least the predetermined number (five) of the identical symbols is to be rearranged (a loosing case) among fifteen symbols, the CPU 106 does not activate the award flag.

As a result of the determination of the symbols to be rearranged in Step S5, the CPU 106 determines whether a combination of symbols for triggering a switch to a free game has occurred along active lines L1 to L5 such as shown in FIG. 3, within the symbol display regions 301 to 315. In a case where the CPU 106 determines a switch to a free game, the CPU 106 activates a free game flag indicating a switch to a free game. The CPU 106 stores the free game flag to a predetermined memory area of the RAM 110. On the other hand, in a case where the CPU 106 does not determine a switch to a free game, the CPU 106 does not activate the free game flag. Subsequently, the CPU 106 advances the processing to Step S6.

In Step S6, the CPU 106 transmits a signal for starting a dynamical display of symbols in each of the symbol display regions 301 to 315 corresponding to the fifteen video reels respectively, to the display/input controller 140. Upon the start of a dynamical display of a set of symbols performed by each of the fifteen video reels, the CPU 106 stands by for a predetermined period of time to elapse (Step S7). When the predetermined period of time has elapsed (“YES” in Step S7), the CPU 106 transmits a signal for executing the rearrangement of a symbol of each of the fifteen video reels which correspond to the symbol display regions 301 to 315 respectively, to display/input controller 140. As a result, the symbols of the fifteen video reels are rearranged (Step S8). Subsequently, the CPU 106 advances the processing to Step S9.

In Step S9, the CPU 106 determines whether the award flag stored in the RAM 110 is activated in Step S5 in the processing for determining symbols to be rearranged. In a case where the award flag is not activated (“NO” in Step S9), the CPU 106 terminates the routine. On the other hand, in a case where the award flag is activated (“YES” in Step S9), the CPU 106 advances the processing to Step S10.

In Step S10, the CPU 106 determines whether the free game stored in the RAM 110 is activated in Step S5 in the processing determining symbols to be rearranged. More specifically, in a case where the free game flag is activated (“YES” in Step S10), the CPU 106 advances the processing to Step S11. On the other hand, in a case where the free game flag is not activated (“NO” in Step S10), the CPU 106 advances the processing to S12.

In Step S11, the CPU 106 executes free game processing. More specifically, the CPU 106 starts a free game and performs free games a predetermined times. Subsequently, the CPU 106 terminates the routine.

In Step S12, the CPU 106 pays out coins corresponding to the number of rearranged identical symbols of at least the predetermined number (five). Here, in a case where there is a wild symbol, which is substitutable for any kind of symbol, the number of wild symbols may be included in the number of the identical symbols. More specifically, the CPU 106 refers to a payout table (not shown) and calculates a payout amount of coins corresponding to the number of rearranged identical symbols of at least the predetermined number (five). The CPU 106 reads the credit amount stored in the RAM 110, adds the calculated payout amount to the credit amount thus read, and stores the resulting value in a predetermined memory area of the RAM 110. The CPU 106 causes the credit amount display unit 49 to display the stored credit amount. Subsequently, the CPU 106 terminates the routine.

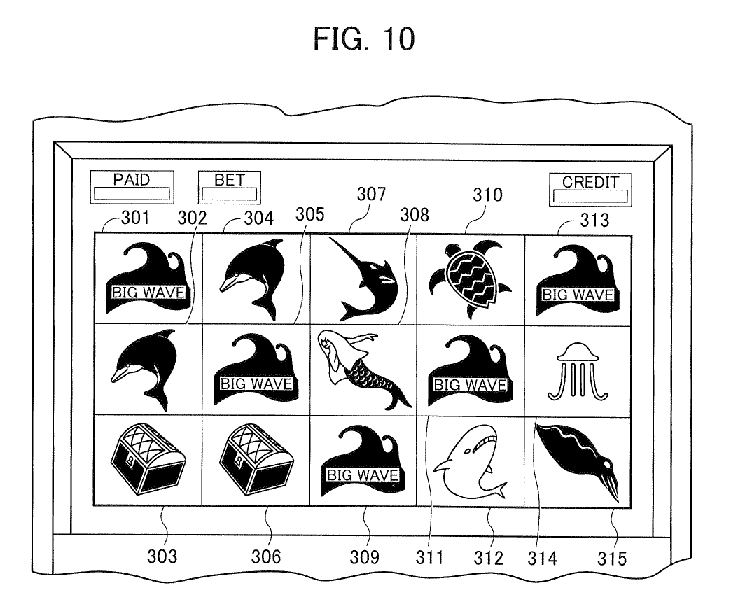

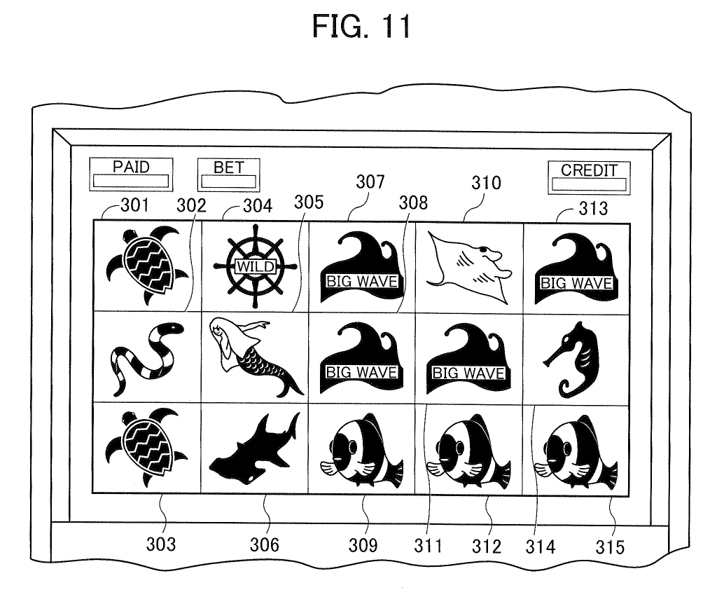

FIG. 7 is a flow chart showing an example of the free game processing (S11) in FIG. 6. FIG. 9 is a diagram showing a payout table related to a free game. FIGS. 10 and 11 are examples of display screens of rendered images of a game, each displayed by the gaming machine 10 according to the present invention. A description is provided referring to those figures arbitrarily.

In Step S1101, the CPU 106 determines a specific symbol associated with a free game. For example, the CPU 106 determines symbols arranged along an active line that have triggered a switching to a free game in a basic game as a specific symbol. More specifically, as shown in FIG. 10, a basic game is performed with the symbol display regions 301 to 315 on the liquid crystal display 30 as the symbol display area for providing an award, and in a case where a combination of symbols (“BIG WAVE” symbols) (the combination including the symbol display regions 301, 305, 309, 311 and 313) is achieved along the active line L4 (refer to FIG. 3), the CPU 106 determines a “BIG WAVE” symbol, which has triggered a switch to a free game, as a specific symbol.

A way to determine a specific symbol is not limited thereto, and an arrangement may be made in which a player can select a specific symbol. For example, a touch panel mechanism for a display may be utilized (refer to numeral 32 in FIG. 5). In other words, upon selecting one of the symbol display regions 301 to 315 in the symbol display area for providing an award via the touch panel 32, the CPU 106 recognizes the selection, and determines a symbol in the selected symbol display region as a specific symbol.

A display to allow a player to select a specific symbol may include: the display screen, which has triggered a switch to a free game such as the abovementioned display screen shown in FIG. 10, and a new display screen, as an initial screen of a free game (for example, a screen displaying a rendered image showing symbols repeatedly rearranged in slow motion, in which all the symbols used in the free game can be observed).

Data related to the specific symbol determined in Step S1101 is stored in the RAM 110 and is utilized in processing for determining symbols (S1103) and processing for extracting pattern data to be rearranged (S1104), which are described later. In addition, a higher probability is applied to the specific symbol to be rearranged in one of the symbol display regions 301 to 315. Subsequent to the processing of Step S1101, the CPU 106 advances the processing to the Step S1102.

In Step S1102, the CPU 106 transmits a signal for starting a dynamical display of a set of symbols in each of the symbol display regions 301 to 315 to the display/input controller 140, causing each of the fifteen video reels to display a dynamical display. Subsequently, the CPU 106 advances the processing to Step S1103.

In Step S1103, the CPU 106 determines whether to display at least a predetermined number (for example, three) of specific symbols, a kind of symbols to be rearranged in a group of the same kind, and isolated symbols to be rearranged. Subsequently, the CPU 106 advances the processing to Step S1104.

In Step S1104, the CPU 106 refers to a rearrangement pattern table (not shown), and extracts rearrangement pattern data corresponding to the symbols to be rearranged, which are determined in the processing of Step S1103. Furthermore, the CPU 106 stores the data thus extracted to a predetermined memory area of the RAM 110. Subsequently, the CPU 106 advances the processing to Step S1105, and in Step S1105, the CPU 106 rearranges symbols based on the extracted rearrangement pattern data. For example, as shown in FIG. 11, the CPU 106 rearranges the predetermined symbol in each of the symbol display regions 301 to 315 based on the rearrangement pattern data. Subsequently, the CPU 106 advances the processing to Step S1106.

In Step S1106, the CPU 106 determines whether at least the predetermined number of specific symbols is rearranged among the rearranged symbols. In the present embodiment, the predetermined number is three. For example, referring to FIG. 11, “BIG WAVE” symbols, which are the specific symbols, are rearranged in the symbol display regions 307, 308, 311, and 313. This indicates that the number of specific symbols satisfies the requirement of rearrangement, or the minimum predetermined number (three). The symbol display regions 307, 308, 311 and 313 may be displayed with visual effects, which allow a player to easily comprehend the game. For example, the symbol display regions 307, 308, 311 and 313 may be highlighted by lights.

Suppose a case of a game in which a player can select a specific symbol. If the player selects an “ANEMONE FISH” symbol as a specific symbol, the rearrangement requirement of at least the predetermined number (three) of the specific symbols is satisfied since “ANEMONE FISH” symbols are rearranged in the symbol display regions 309, 302, and 315. Furthermore, in a case where a “TURTLE” symbol has been selected as a specific symbol, the rearrangement requirement of at least the predetermined number (three) of the specific symbols is satisfied since “TURTLE” symbols are determined as having been rearranged in the symbol display regions 301, 303, and 304, by including a “WILD” symbol.

In the Step S1106, in a case where the CPU 106 determines that at least the predetermined number of the specific symbols are rearranged, the CPU 106 increments a count value X (Step S1107). Subsequently, the CPU 106 advances the processing to Step S1109.

On the other hand, in a case where the CPU 106 determines that at least the predetermined number of the specific symbols are not rearranged in Step S1106, the count value X is reset to “0” (Step S1108). The count value X is stored in the RAM 110. Subsequently, the CPU 106 advances the processing to Step S1110.

In Step S1109, the CPU 106 provides an award corresponding to the count value X. Providing an award based on the count value X is a type of processing to increase a payout amount of a predetermined award based on the number of consecutive rounds in each of which the specific symbol is rearranged, while performing a free game.

For example, an award qualified in a basic game that has been performed before a switch to a free game is carried over at the start of a free game. The award is set as a base award. The base award may be set so as to vary depending on a combination of symbols and the kind of symbols forming a combination. A credit amount applied to the base award is stored in a predetermined memory area of the RAM 110, for example. The CPU 106 increases a payout amount for the base award by addition or multiplication of a value, which is determined based on the number of consecutive rounds of the free game in each of which the specific symbol is rearranged.

More specifically, the award is provided referring to a payout table for a free game shown in FIG. 9. For example, for a free game having five games, the award increases as the number of consecutive games (X) equivalent with the count value X described above increases. For example, the award increases with respect to a base award of a predetermined value A according to the number of consecutive games (X) in the following manner: B equals 2A, C equals A×B, and D equals A×B×C. The selection of values A, B, C and D is not limited to the example described above, but there may be several alternatives. Referring to the payout table mentioned above, the CPU 106 reads a credit amount of the base award stored in the RAM 110, and multiplies (or adds) the credit amount thus read by a calculated (recalculated) payout amount, for example. Subsequently, the CPU 106 stores the resulting value to a predetermined memory area of the RAM 110. The CPU 106 displays the stored value on the credit amount display unit 49. Subsequent to the processing of Step S1109, the CPU 106 advances the processing to Step S1110.

In Step S1110, the CPU 106 increments the number of games N. The number of games N is stored in the RAM 110. In the following Step S1111, the CPU 106 determines whether the number of games N is equal to or greater than a predetermined value. The predetermined value in the present embodiment is five. In other words, in the present embodiment, when a game is advanced to a free game from a basic game, symbols are rearranged five times. That is, the CPU 106 advances the processing to Step S1102 in a case where the CPU 106 determines that the number of games N is less than a predetermined value (N=5), and advances the processing to Step S1120 in a case where the CPU 106 determines that the number of games N equals the predetermined value (N=5). In Step S1120, the CPU 106 resets the count value X and the number of games N, and terminates the routine.

According to the abovementioned embodiment of the present invention, a free game including the processing in Step S1102 to S1110 is performed, until the number of games N reaches a predetermined value (for example, N=5). During the free game, each time specific symbols are rearranged in the symbol display area for providing an award (the symbol display regions 301 to 315 in the present embodiment), an award is displayed on the display 30, which equals the base award multiplied by (or added to) the value determined according to the number of consecutive rounds of the free game in each of which the specific symbol is rearranged. With such a configuration, the gaming machine can provide a player-friendly game with speed and excitement without interruption of a game flow.

FIG. 8 is a flow chart showing another example of free game processing (S11) in FIG. 6. Since the processing of Step S1101 to S1106 is the same as that of FIG. 7, a description for the same portion is omitted.

In a case where the CPU 106 determines that at least a predetermined number (three) of specific symbols is rearranged in the processing of Step S1106, the CPU 106 increments the count value X (Step S1107). Subsequently, the CPU 106 advances the processing to S1110.

On the other hand, in a case where the CPU 106 determines that the specific symbols less than a predetermined number are rearranged, the CPU 106 advances the processing to Step S1109a. In Step S1109, the CPU 106 provides an award based on a count value X. Providing the award based on the count value X is a type of processing to increase a payout amount of a base award based on the number of consecutive rounds in each of which the specific symbol is rearranged while performing a free game (refer to explanation of FIG. 7, as an example). In other words, in a case where the specific symbols are not rearranged in the symbol display area for providing an award, the CPU 106 pays out an award corresponding to the number of consecutive games (X) that has been stored for the specific symbol rearranged in a previous game. More specifically, an award is provided referring to a payout table for a free game shown in FIG. 9. Furthermore, similar to the description of FIG. 7, the CPU 106 determines a base award according to a display pattern of symbols in the symbol display area for providing an award that has triggered a switch from a basic game to a free game. The CPU 106 provides an increased award based on the base award according to the number of consecutive games (X) of the rearranged specific symbol, which has been stored for the previous game. Subsequently, the CPU 106 resets the count value X to 0 (Step S1108). The CPU 106 advances the processing to S1110.

In Step S1110, the CPU 106 increments the number of games N. The number of games N is stored in the RAM 110. In the following Step S1111, the CPU 106 determines whether the number of games N is equal to or greater than a predetermined value.

In a case where the CPU 106 determines that the number of games N is less than the predetermined value (N=5), the CPU 106 advances the processing to Step S1102. In other words, after executing the processing of providing an award based on the number of consecutive games (X) for the game in which the specific symbol is rearranged prior to the current game in which a consecutive rearrangement of the specific symbol is stopped, the CPU 106 resets the number of consecutive games (X) and performs subsequent games.

In a case where the CPU 106 determines that the number of games N reaches the predetermined value (N=5), the CPU 106 advances the processing to Step S1112. In Step S1112, the CPU 106 compares the count value X and the number of games N, and in a case where the CPU 106 determines that they are the same value, the CPU 106 advances the processing to Step S1109b. In other words, in a case where the specific symbol is rearranged in each round of a free game and the CPU 106 determines that the number of consecutive games (X) is equal to the number of games N, there is no step to provide an award until the number of games N equals the predetermined number of free games. Thus, undergoing Step 1109b which is similar to the Step S1109a, the CPU 106 provides an award, which is an increased award with respect to the base award (based on the count value X). Subsequently, the CPU 106 advances the processing to Step S1120, resets the count value X and the number of games N, and terminates the routine.

According to the abovementioned embodiment of the present invention, a free game including the processing in Step S1102 to S1110 is performed, until the number of games N reaches a predetermined value (for example, N=5). During the free game, each time the specific symbol is rearranged in the symbol display area for providing an award (the symbol display regions 301 to 315 in the present embodiment), the gaming machine grades up a factor to be multiplied (or added) to the base award displayed on the display 30. In a case where the specific symbol is not rearranged in the symbol display regions 301 to 315 in a subsequent game, the gaming machine provides the factor graded up in the previous game so as to multiply it to the base award. With such a configuration, the gaming machine can provide a player-friendly game with speed and excitement without interruption of a game flow.

While the embodiment of the gaming machine according to the present invention has been described, it is to be understood that the above description is intended to be illustrative, and not restrictive, and any changes in design may be made to specific configurations such as various means. Moreover, it should be understood that the advantages described in association with the embodiments are merely a listing of most preferred advantages, and that the advantages of the present invention are by no means restricted to those described in connection with the embodiments.

For example, although a description is provided of the present invention that an award is provided when a group of symbols forms a combination of symbols along an active line during a free game (bonus game), an award may alternatively be provided when a combination of symbols based on the number of identical symbols occurs.

Furthermore, although the description is provided that the base award is used in a free game, when a game is advanced to a free game from a basic game, the base award may be omitted, and the award may be increased based on the number of consecutive rounds in each of which a specific symbol is rearranged during a free game, for example.

Moreover, in the present embodiment, the symbol display regions 301 to 315 on the liquid crystal display 30 of the gaming machine 10 are a matrix of three rows and five columns in which the video reels are provided, respectively, but it is not limited thereto. Alternatively, a video reel or a mechanical reel that is divided into five columns may be adopted. In this case, the symbol display regions 301 to 303 are included in the first column which is divided into a plurality of symbol display regions, the symbol display regions 304 to 306 are included in the second column which is divided into a plurality of symbol display regions, the symbol display regions 307 to 309 are included in the third column which is divided into a plurality of symbol display regions, the symbol display regions 310 to 312 are included in the fourth column which is divided into a plurality of symbol display regions, and the symbol display regions 313 to 315 are included in the fifth column which is divided into a plurality of symbol display regions.

What is claimed is:

1. A gaming machine, comprising:
a display having a plurality of symbol display regions and displaying a symbol to be rearranged in each of the symbol display regions for each round of a game;
an input device for starting a basic game in which an award is provided based on an arrangement of symbols rearranged in a symbol display area for providing an award, the symbol display area including the plurality of symbol display regions on the display, a type of the award being determined according to one of a number of identical symbols and a combination of symbols lying along an active line; and
a controller configured to execute the processing comprising:
(a) starting a basic game, and after performing at least one round of the basic game, switching the basic game to a free game;
(b) rearranging a predetermined symbol randomly in each region of the symbol display area for providing an award on the display for each round of the free game; and
(c) if an arrangement of symbols rearranged in the symbol display area for providing an award matches an arrangement entitled to a predetermined award after a plurality of rounds of the free game, increasing an amount of payout for the predetermined award according to a number of consecutive rounds previously played of the free game in each of which a specific symbol is rearranged in the symbol display area for providing an award.

2. The gaming machine according to claim 1, wherein the specific symbol is selected by a player.

3. A gaming machine, comprising:
a display having a plurality of symbol display regions and displaying a symbol to be rearranged in each of the symbol display regions for each round of a game;
an input device for starting a basic game in which an award is provided based on an arrangement of symbols rearranged in a symbol display area for providing an award, the symbol display area including the plurality of symbol display regions on the display, a type of the award being determined according to one of a number of identical symbols and a combination of symbols lying along an active line; and
a controller configured to execute the processing comprising:
(a) starting a basic game, and after performing at least one round of the basic game, switching the basic game to a free game;
(b) rearranging a predetermined symbol randomly in each region of the symbol display area for providing an award on the display for each round of the free game;
(c) at the end of each round of the free game, updating and storing a number of consecutive rounds of the free game in each of which a specific symbol is rearranged in the symbol display area for providing an award; and
(d) if the specific symbol is not rearranged in the symbol display area for providing an award in one round of the free game, providing an award based on the number of consecutive rounds of the free game in each of which the specific symbol is rearranged, the number being stored in the previous round of the free game.

4. The gaming machine according to claim 3, wherein a base award is predetermined in the free game and a value for one of multiplying and adding to the base award is changed based on the number of consecutive rounds of the free game in each of which the specific symbol is rearranged.

5. A gaming machine, comprising:
a display having a plurality of symbol display regions and displaying a symbol to be rearranged in each of the symbol display regions for each round of a game;
an input device for starting a basic game in which an award is provided based on an arrangement of the symbols rearranged in a symbol display area for providing an award, the symbol display area including the plurality of symbol display regions on the display, a type of the award being determined according to one of a number of identical symbols and a combination of symbols lying along an active line; and
a controller configured to execute the processing comprising:
(a) starting a basic game, and after performing at least one round of the basic game, switching the basic game to a free game;
(b) rearranging a predetermined symbol randomly in each region of the symbol display area for providing an award on the display for each round of the free game;
(c) at the end of each round of the free game, updating and storing a number of consecutive rounds of the free game in each of which a specific symbol is rearranged in the symbol display area for providing an award; and
(d) if the specific symbol is not rearranged in the symbol display area for providing an award in one round of the free game, providing an award based on a payout table that correlates a payout with the number of consecutive rounds of the free game in each of which the specific symbol is rearranged, the number being stored in the previous round of the free game.

6. A gaming machine, comprising:
a display having a plurality of symbol display regions and displaying a symbol to be rearranged in each of the symbol display regions for each round of a game;
an input device for starting a basic game in which an award is provided based on an arrangement of symbols rearranged in a symbol display area for providing an award, the symbol display area including the plurality of symbol display regions on the display, a type of the award being determined according to one of a number of identical symbols and a combination of symbols lying along an active line; and
a controller configured to execute the processing comprising:
(a) starting a basic game, and after performing at least one round of the basic game, switching the basic game to a free game;
(b) rearranging a predetermined symbol randomly in each region of the symbol display area for providing an award on the display for each round of the free game;
(c) at the end of each round of the free game, updating and storing a number of consecutive rounds of the free game in each of which a specific symbol is rearranged in the symbol display area for providing an award; and
(d) if the specific symbol is not rearranged in the symbol display area for providing an award in one round of the free game, increasing an amount of an award determined based on an arrangement of symbols displayed in the symbol area for providing an award, which has triggered a switch from the basic game to the free game in processing (a), according to the number of consecutive rounds of the free game, which is stored in the previous round of the free game in which the specific symbol is rearranged, and providing the increased amount of the award.

7. A gaming machine, comprising:
a display having a plurality of symbol display regions and displaying a symbol to be rearranged in each of the symbol display regions for each round of a game;
an input device for starting a basic game in which an award is provided based on an arrangement of symbols rearranged in a symbol display area for providing an award, the symbol display area including the plurality of symbol display regions on the display, a type of the award being determined according to one of a number of identical symbols and a combination of symbols lying along an active line; and
a controller configured to execute the processing comprising:
(a) starting a basic game, and after performing at least one round of the basic game, switching the basic game to a free game;
(b) rearranging a predetermined symbol randomly in each region of the symbol display area for providing an award on the display for each round of the free game;
(c) at the end of each round of the free game, updating and storing a number of consecutive rounds of the free game in each of which a specific symbol is rearranged in the symbol display area for providing an award;
(d) if an arrangement of the symbols displayed in the symbol display area for providing an award matches an arrangement entitled to an award as a result of a round of the free game, providing the award according to the number of consecutive rounds of the free game cumulatively stored in processing (c) in each of which the specific symbol is rearranged; and
(e) if the specific symbol is not rearranged in the symbol display area for providing an award, resetting the number of consecutive rounds of the free game in processing (c) in each of which the specific symbol is rearranged, and performing subsequent rounds of the free game.
